(19) United States
(12) Patent Application Publication
(10) Pub. No.: US 2008/0284237 A1
(43) Pub. Date: Nov. 20, 2008

(54) Bicycle wheel rim assembly with flat spokes

(76) Inventor: Rick Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,512

(22) Filed: May 15, 2007

(51) Int. Cl. B60B 1/04

(52) U.S. Cl. 301/58; 301/59; 301/104

(57) ABSTRACT

A bicycle wheel rim assembly includes a rim and a hub is located at a center of the rim. A plurality of spokes are connected between the hub and the rim. Each spoke is a flat board and includes a first end which is engaged with one of the notches defined in the hub and a plurality threaded sections extend from a second end of each spoke, the threaded sections are fixed to the rim.

### FIELD OF THE INVENTION

The present invention relates to a bicycle wheel rim assembly having flat spokes which of which has one end snapped to notches of the hub and the other end of each spoke is fixedly connected to the rim.

### BACKGROUND OF THE INVENTION

A conventional bicycle rim assembly generally includes a rim and a hub is located at a center of the rim, a plurality of spokes are connected between the hub and the rim. The two ends of the spokes are locked at the hub and the rim so as to have proper tension to maintain the wheel rim. A plurality of pads are located at the rim and the spokes extend through the pads and are fixedly connected by a nut. The hub is cooperated with fixing members to be fixedly connected the spokes to the hub. The spokes are made by metal and includes a consistent and small diameter and it requires a lot of processes to fix the spokes to the rim and the hub. Due to the small diameter, a certain number of spokes are required to maintain the shape of the rim and the more the spokes are installed, the higher the resistant force is generated when the wheel rotates.

The present invention intends to provide a bicycle wheel rim assembly which includes a hub with notches so that the spokes are easily snapped with the notches, and the other end of each spoke have two threaded sections which are fixedly connected to the rim. Each spoke is flat and a width thereof gradually increases in radial direction from the hub.

### SUMMARY OF THE INVENTION

The present invention relates to a bicycle wheel rim assembly which comprises a rim with a hub located at a center of the rim. A plurality of notches are defined in the hub. A plurality of spokes are connected between the hub and the rim, wherein each spoke is a flat board and has a first end engaged with one of the notches and a plurality threaded sections extend from a second end of each spoke, the threaded sections are fixed to the rim.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle wheel rim assembly of the present invention;

FIG. 2 is an exploded view to show the bicycle wheel rim assembly of the present invention;

FIG. 3 is an enlarged view to show the sphere on the first end of the spokes is engaged with the notch and recess of the hub of the present invention;

FIG. 4 is a perspective view to show the spoke of the present invention;

FIG. 5 is a cross sectional view of the spoke of the present invention;

FIG. 6 is another embodiment of the spoke of the present invention, and

FIG. 7 shows the wheel rim assembly using the spokes in FIG. 6, and

FIG. 8 shows another arrangement of the spokes of the wheel rim assembly of the present invention.

### DETAILED DESCRIPTION OF THE PREFERRED EMBODIMENT

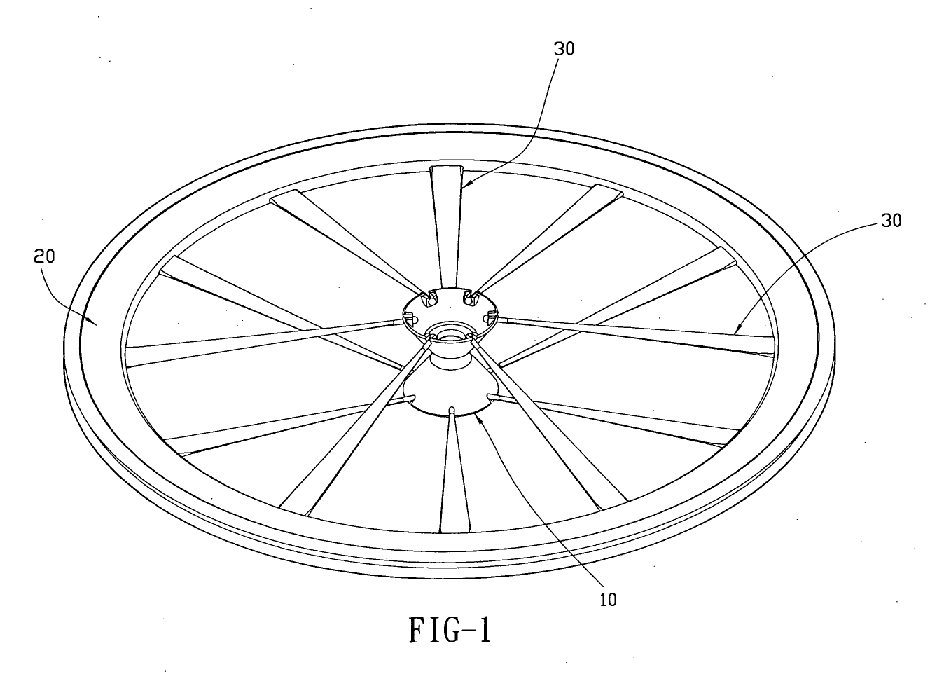

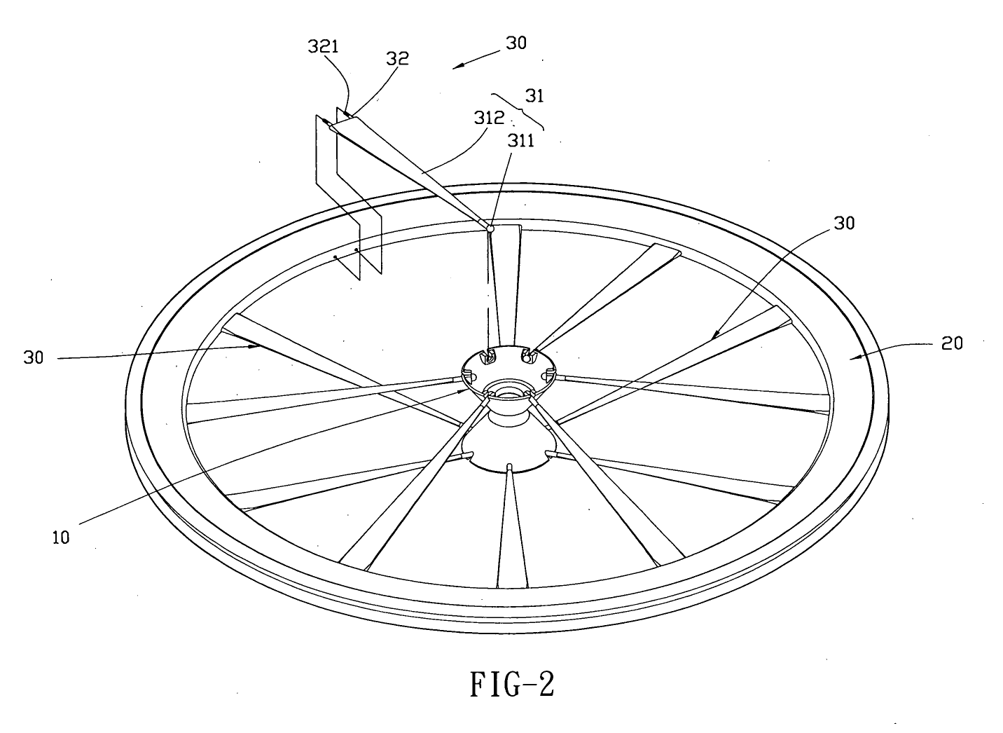

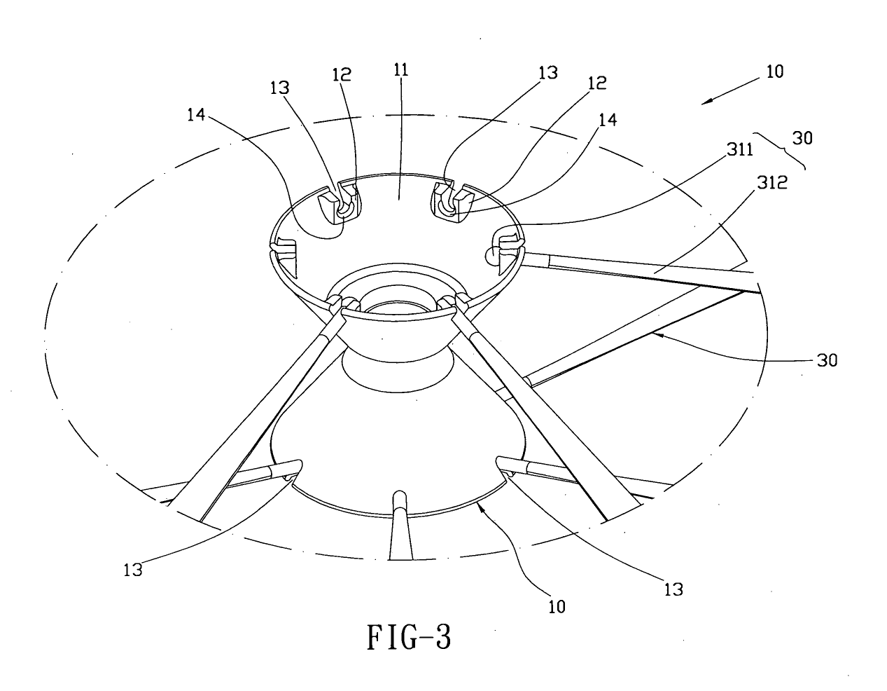

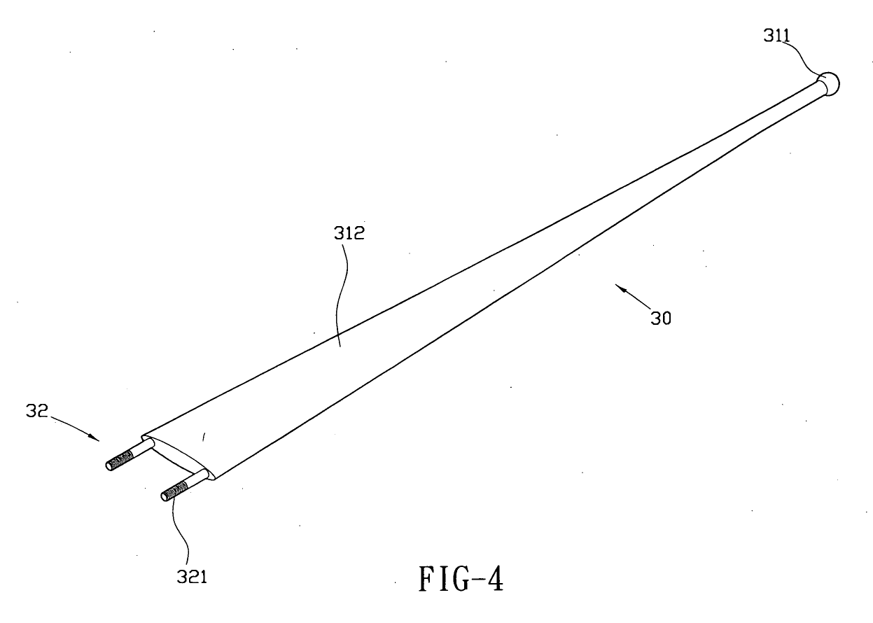

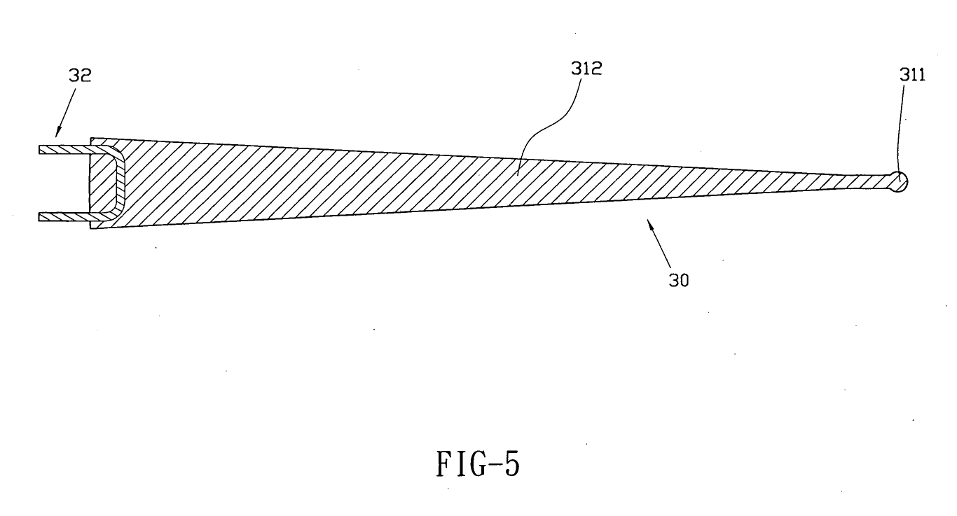

Referring to FIGS. 1 to 5, the bicycle wheel rim assembly of the present invention comprises a rim 20 having a plurality pairs of holes 21 defined in an inner periphery thereof. A hub 10 is located at a center of the rim 20 and includes two enlarged ends and a narrow neck is connected between the two enlarged ends. Each enlarged end has an open end 11 and a plurality of notches 13 are defined in a periphery of each of the open ends of the hub 10. A plurality of U-shaped protrusions 12 extend inward from each of two open ends 11 of the hub 10 and each the notch 13 communicates with the U-shaped protrusion 12 corresponding thereto. A recess 14 is defined in each of the protrusions 12 and communicates with the notch 13 corresponding thereto,

A plurality of spokes 30 are connected between the hub 10 and the rim 20, wherein each spoke 30 is a flat board and a first end of each spoke 30 has a sphere 311 which is engaged with one of the notches 13 and the recess 14. A U-shaped member is partially merged in a second end of each spoke 30 and two legs of the U-shaped member extend out from the second end of each spoke 30. The two legs include two threaded sections 321 which extend from the second end 32 of each spoke 30 and are securely connected with the holes 21 of the rim 20. Each spoke 30 includes a flat body portion 312 and a width of the flat body portion 312 gradually increases in the radial direction from the first end toward the second end thereof. The flat board of each of the spokes 30 and the rim 20 are located at the same plane.

The U-shaped member is made by metal and the flat board of each spoke 30 can be made by plastic, fiberglass or composite material. The spokes 30 includes larger cross sectional compared with the conventional spokes so that the shocks from ground can be absorbed more efficiently by the spokes 30. The sphere 311 and the flat body portion 312 are made integrally and the integral structure provides the spokes 30 proper flexibility which effectively maintains the shape of the rim 20. The sphere 311 can be easily engaged with the notch 13 and the recess 14 so as to reduce the assembly time required.

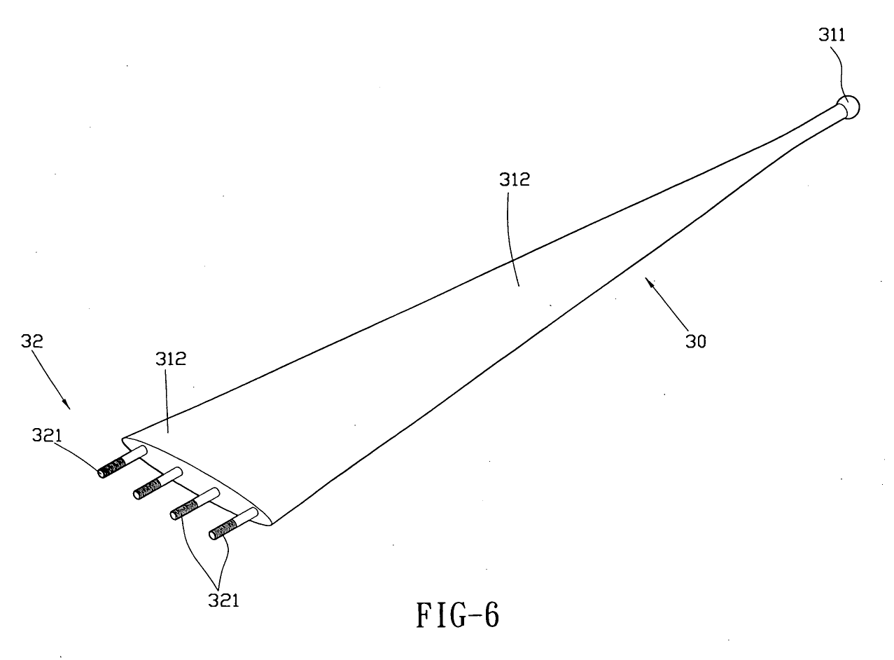

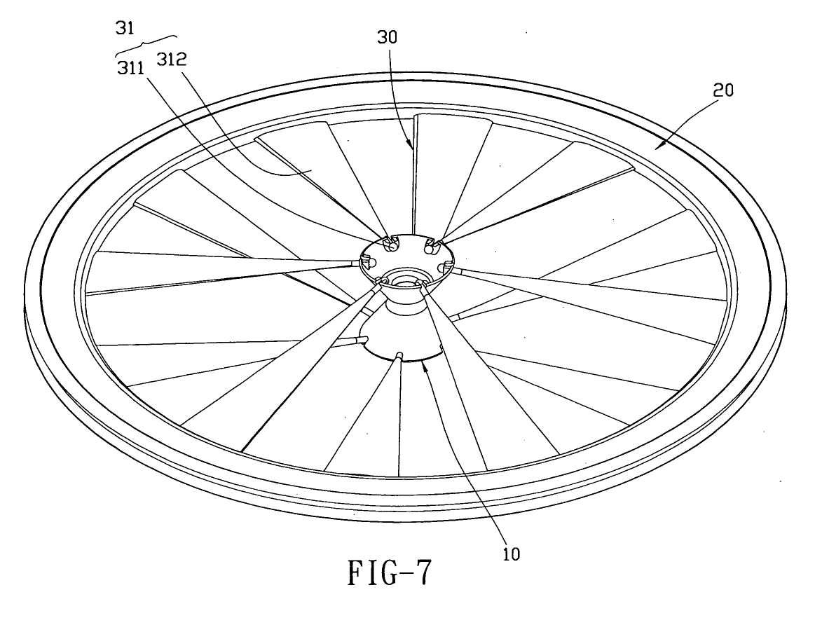

FIGS. 6 and 7 show that the width of the second end of each spoke 30 is wider and the number of the threaded sections 321 is four.

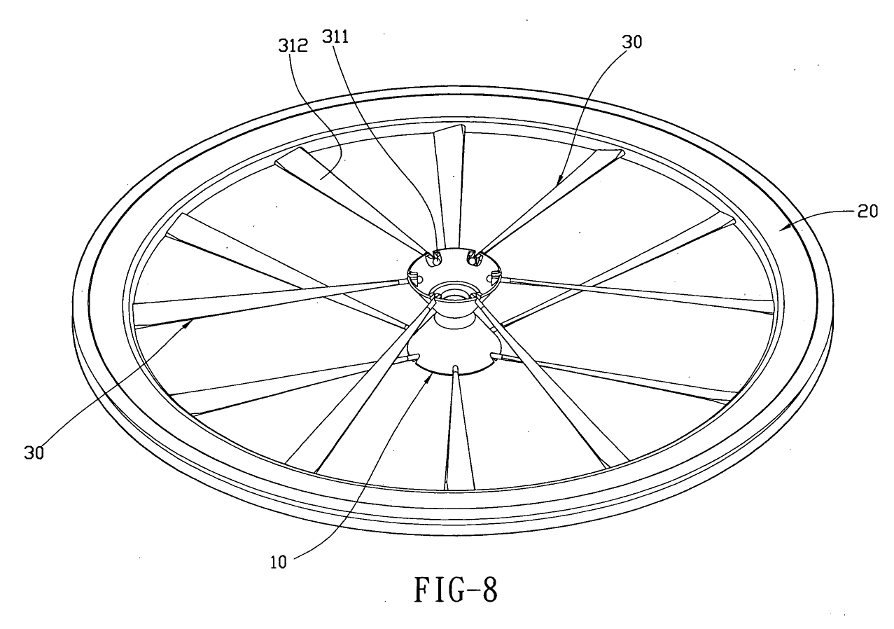

FIG. 8 shows that the flat board of each of the spokes 30 and the rim 20 are located at two different planes. In other words, each spoke 30 is arranged such that an angle is defined between the plane that the spoke 30 is located and the plane that the rim 20 is located.

While we have shown and described the embodiment in accordance with the present invention, it should be clear to those skilled in the art that further embodiments may be made without departing from the scope of the present invention.

What is claimed is:

1. A bicycle wheel rim assembly comprising:
a rim;
a hub located at a center of the rim and a plurality of notches defined in the hub, and
a plurality of spokes connected between the hub and the rim, each spoke being a flat board and having a first end engaged with one of the notches and a plurality threaded sections extending from a second end of each spoke, the threaded sections being fixed to the rim.

2. The assembly as claimed in claim 1, wherein a plurality of U-shaped protrusions extend inward from each of two open ends of the hub and each the notch communicates with the U-shaped protrusion corresponding thereto.

3. The assembly as claimed in claim 2, wherein a recess is defined in each of the protrusions and communicates with the notch corresponding thereto, a sphere is connected to the first end of each spoke and is engaged with the recess and the notch.

4. The assembly as claimed in claim 2, wherein the hub includes two enlarged ends and a narrow neck is connected between the two enlarged ends, each enlarged end has the open end.

5. The assembly as claimed in claim 1, wherein each spoke includes a flat body portion and a width of the flat body portion gradually increases in the radial direction from the first end toward the second end thereof.

6. The assembly as claimed in claim 2, wherein a U-shaped member is partially merged in the second end of each spoke and two legs of the U-shaped member extend out from the second end of each spoke, the two legs include the two threaded sections.

7. The assembly as claimed in claim 1, wherein the flat board of each of the spokes and the rim are located at the same plane.

8. The assembly as claimed in claim 1, wherein the flat board of each of the spokes and the rim are located at two different planes.
